(19) United States
(12) Patent Application Publication
(10) Pub. No.: US 2025/0390899 A1
(43) Pub. Date: Dec. 25, 2025

(54) USER FEEDBACK MANAGEMENT

(71) Applicant: Honeywell International Inc., Charlotte, NC (US)

(72) Inventors: Ankit Singh, Apex, NC (US); Timothy Sneed, Beachwood, NJ (US); Abhishek Hiremath, Scarborough (CA)

(21) Appl. No.: 18/751,353

(22) Filed: Jun. 24, 2024

(51) Int. Cl. G06Q 30/0203

(52) U.S. Cl. CPC G06Q 30/0203

(57) ABSTRACT

Approaches for implementing incentive-based user feedback mechanism related to an application are described. In an example, a feedback session is initiated by sending a prompt message to the user's device upon detecting a feedback trigger. Thereafter, a questionnaire with questions based on user attributes is transmitted, and user responses are received. Responses are analyzed to assign metric scores to users, modifying order or content of questions of the questionnaire.

### BACKGROUND

Applications, in the modern digital era, have become a cornerstone of both personal and professional environments, serving as the primary interface through which users interact with a variety of services and functionalities. These applications, which may be either locally installed on a device or accessed through the internet, are designed to perform a wide range of tasks, catering to diverse user requirements across various domains.

Such applications typically offer a variety of services, including but not limited to data storage (where users can securely save and retrieve data), communication services (which facilitate interactions through messaging, email, and social networking features), productivity tools (that assist in document creation, project management, and scheduling) and entertainment services. Depending on the client requirements, the number of services that are provided may vary. For example, the number of features or services of applications may be accessible to clients having different service-level agreements with the application.

Gathering feedback from users forms one of the core actions while providing services through applications. Such feedback is useful for the iterative development of applications, providing developers with insights into user experiences and expectations. By incorporating user feedback, developers may prioritize enhancements and align the application's evolution with actual user requirements. Existing feedback mechanisms in these applications often involve user surveys, feedback forms, and direct user engagement sessions.

### BRIEF DESCRIPTION OF FIGURES

Systems and/or methods, in accordance with examples of the present subject matter are now described and with reference to the accompanying figures, in which:

FIG. 1 illustrates a system for implementing an incentive-based feedback mechanism, as per an example;

FIG. 2 illustrates an application environment implementing a feedback management system for managing and analyzing user feedback, as per an example;

FIG. 3 illustrates a detailed block diagram of a feedback management system for managing and analyzing user feedback, as per an example;

FIG. 4 illustrates an exemplary call flow diagram representing communication between various computational entities of a cloud-based application ecosystem, as per an example;

FIG. 5 illustrates another call flow diagram representing communication between various computational entities of a cloud-based application ecosystem, as per an example;

FIG. 6 illustrates a method for customizing a feedback questionnaire based on user feedback, as per an example;

FIG. 7 illustrates a method for implementing an incentive-based feedback mechanism, as per an example;

FIG. 8 illustrates a detailed method for customizing feedback questionnaire based on user feedback, as per an example;

FIG. 9 illustrates a method for modifying workflow of an application based on user feedback, as per an example; and

FIG. 10 illustrates a system environment implementing a non-transitory computer readable medium for modifying workflow of an application based on user feedback, as per an example.

### DETAILED DESCRIPTION

Applications have afforded numerous advantages to businesses and individuals, which in turn has resulted in their widespread adoption across different verticals. Such applications offer scalable, accessible, and secure computing solutions. They enable remote working, real-time collaboration, and efficient resource management, driving innovation and operational efficiency across various industries. In the realm of such cloud-based applications, the ability to adapt and evolve in response to user feedback is paramount. The dynamic nature of such cloud services, thus, necessitates a feedback system that is both responsive and engaging to ensure that the applications continue to meet the evolving demands of users.

Existing feedback mechanisms, such as static surveys, user forums, and direct customer support interactions, have been the mainstay for gathering user insights. However, these methods often fail in certain areas. For example, static surveys may not capture the nuanced experiences of different user roles, leading to a one-size-fits-all approach that lacks personalization. Direct interactions, although valuable, are resource-intensive and may not be scalable for large user bases.

Despite such challenges, the utility of feedback cannot be underscored enough. One challenge in this aspect involves designing mechanisms that may foster high levels of user engagement in feedback activities. Generally, users may be disinclined to participate due to time constraints, perceived lack of impact, feedback questions not being aligned with their requirement or absence of direct benefits etc. This leads to low response rates and a feedback loop that does not accurately represent the user population. Moreover, the incentives offered for feedback provision are often not compelling enough to motivate sustained and meaningful participation, or constructive feedback. Another aspect of the technical problem is the integration of feedback into the application development cycle. The process is frequently manual, involving sorting through feedback, identifying trends, and prioritizing actions. This may result in delays in addressing user-reported issues and implementing suggestions, which in turn may affect the application's relevance and user satisfaction.

The technical problem addressed by the present disclosure is to create a feedback mechanism that not just solicits user feedback but does so in a manner that is dynamic, engaging, and rewarding for the users. The approaches of the present subject matter aim to overcome the challenges of low user engagement and inadequate incentivization by introducing an incentive-based mechanism that encourages users to provide feedback. These approaches streamline the feedback integration process, ensuring that user insights are rapidly and effectively translated into application improvements.

Approaches for implementing an incentive-based feedback mechanism for applications are described. The feedback mechanism may be implemented for various applications across multiple industries, such as life sciences, finance, education, retail, and technology. To this end, a feedback management system may be implemented for implementing the incentive-based feedback mechanism. The implementation of such feedback management system is described in the context of a cloud-based application to obtain user feedback from a user operating on a client device. Although description provided in subsequent paragraphs is provided with reference to cloud-based application, the process may be implemented for any other application, such as an on-premises applications, mobile applications, web applications, desktop applications, hybrid applications, service-based applications, enterprise applications, open-source applications, embedded applications, and many more, without limitation.

In operation, when a feedback trigger, indicating that a user has performed an action on a client device indicating intention of the user to provide feedback, is detected from the client device of the user, a prompt message is transmitted to the user's client device to initiate a feedback session related to an application. In an example, the application related to which the feedback session has been initiated is the application with which the user is interacting on the client device. Thereafter, a set of questions may be extracted from a repository to form a first questionnaire. The set of questions are selected based on specific user attributes. In an example, the user attributes are determined based on one of a profile of the user comprising the user's designated role in the application, data corresponding to the user's historical interaction with the application, frequency of interaction with the application, and many more parameters which helps in understanding user's preferences and requirements.

Once the first questionnaire is prepared, it is transmitted to the client device over a network and presented on a display of the client device to be viewed and responded to by the user. As the user responds to the questions, the user response to a first question among the questions of the first questionnaire is received. The user response is then evaluated, and a quantifiable metric score is assigned to the user for the user's response. In an example, the metric score may be allocated to the user on providing the response. The metric score that may be allocated may be dependent on the number of questions for which the response may have been provided. The metric score may also be dependent on a weightage associated with the question that may have been responded to by the user.

In an example, the metric score may accumulate over a series of responses to multiple questions provided by the user. Thereafter, the accumulated metric score may be compared with a plurality of predetermined threshold milestone. Based on the comparison, when it is determined that the user's accumulated metric score has exceeded a threshold milestone of the plurality of threshold milestones, the status or state of the user may be changed to an augmented state, wherein which an augmented set of functions, features, or services may be available to the user within the application.

It may be noted that, in instances involving multiple threshold values, different features, services, access or privileges within any application or across different applications, may be provided. Ever-increasing access to different functions incentivizes sustained user interaction over time with the feedback process. As users provide feedback and accumulate metric scores, they may exceed successive thresholds, each unlocking a new tier of features or services.

It is pertinent to note that for capturing nuanced feedback that reflects the diverse experiences of users, the questionnaire may be modified based on individual responses to ensure continued relevance and effectiveness of the feedback mechanism. In an example, once the user has responded to the first question in the first questionnaire, the response is analyzed to determine meaningful insights from the user response indicating patterns, trends, and sentiments of the user behind that response. In an example, the analysis may be based on computer-implementable techniques, such as natural language processing (NLP), to determine underlying sentiments and viewpoints expressed by the user. Based on the insights gained from the analysis, the questions of the first questionnaire may be modified.

In addition, one or more workflows may be modified, or new tasks may be created based on analyzed user feedback. For example, upon analyzing the user's response, control instructions may be generated. The control instructions are such that when executed, are to implement modification in the identified workflow or create new tasks within the application which are to be catered by development team.

The above-described approaches may aid further refining operation of applications through the incentive-based feedback mechanism. As explained above, such approaches enhances user engagement and incentivize participation. Furthermore, the present approaches enable providing questions determined based on user attributes, analyzing responses to detect user sentiment and usage patterns, and dynamically adjusts the questionnaire to enhance relevance. These and other aspects are further described in relation to the accompanying figures.

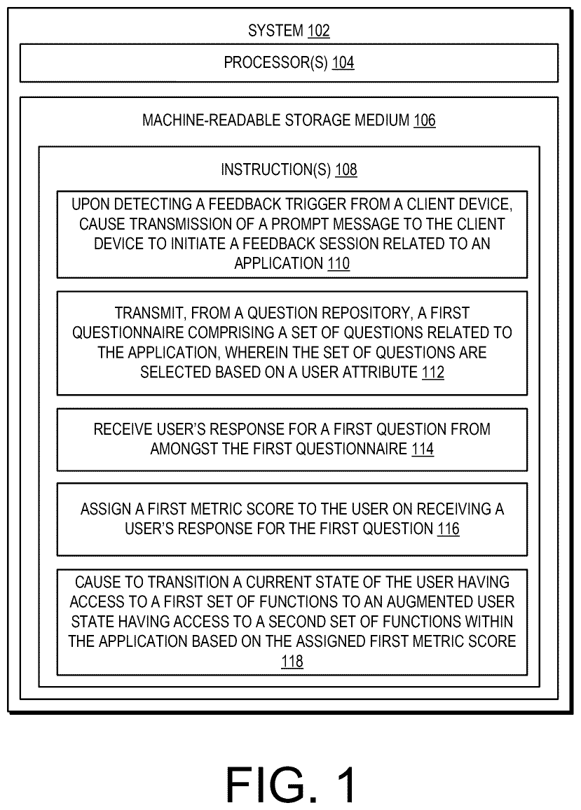

FIG. 1 illustrates a system 102 for implementing an incentive-based feedback mechanism, as per an example. The system 102 includes a processor 104 and a machine-readable storage medium 106 which is coupled to, and accessible by, the processor 104. The system 102 may be implemented in any computing system, such as a storage array, server, desktop or a laptop computing device, a distributed computing system, or the like. Although not depicted, the system 102 may include other components, such as interfaces to communicate over the network with other systems or data repositories, communicate with external storage or computing devices, display, input/output interfaces, operating systems, applications, data, and other software or hardware components (all of which have not been depicted for sake of conciseness). In an example, machine-readable storage medium 106 may further include instruction(s) 108.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instruction(s) 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like.

In operation, the processor 104 may fetch and execute instruction(s) 108 for performing one or more actions, as discussed further. In an example, the execution of instructions 110 may involve the system 102 detecting a specific user interaction by a user on a client device as a feedback trigger to initiate a feedback session. For example, on detecting the feedback trigger, the system 102 generates a prompt message, and transmits it to the user's client device. This prompt message invites the user to participate in the feedback session or feedback process, thereby facilitating the collection of user inputs or feedback in relation to their experience while operating an application.

Continuing further, once the feedback session has been initiated, the instructions 112 may be executed to transmit a first questionnaire related to the application to the user's client device for obtaining user feedback. For example, the system 102 extract a set of questions from a repository which are to be transmitted as the first questionnaire to the user's client device. In an example, the extraction of questions is based on user attributes, such as user's designated role in the application and user's historical interaction with the application. This process involves selecting questions that are pertinent to the user's role and historical interaction with the application.

Thereafter, the instructions 114 may be executed to receive user's response for a first question from amongst the first questionnaire. For example, the system 102 receives the user's response for the first question from the user's client device. In an example, the user at the client device may provide response in one of a free text format, a multiple-choice selection, or other response types.

Once the user response is received, the instructions 116 may be executed to assign a quantifiable score, or a first metric score, to the user based on the question answered from the first questionnaire. For example, the system 102 assigns the first metric score based on a weight which is associated with each question, reflecting its relevance or potential impact on the application's enhancement. In an example, the system 102 may use algorithms or rules to calculate the metric scores, which may then be assigned to the user.

Based on the assigned first metric score, the instructions 118 may be executed to facilitate the transition of a current state of the user to an augmented state within the application. For example, the system 102, based on the first metric score, causes transition of the current state of the user having access to a first set of functions within the application to the augmented state having access to a second set of functions. In an example, this transition is dependent upon the user accumulating a sufficient metric score, as determined by comparing the assigned metric score against predefined threshold milestones. Upon exceeding the threshold milestone, the system 102 may enable additional functions, features, or services within the application, thereby allowing the user access to the second set of functions. It may be noted that this process is designed to be automated, ensuring that the user's progression to the augmented state is seamless and directly correlated to their engagement and feedback contributions.

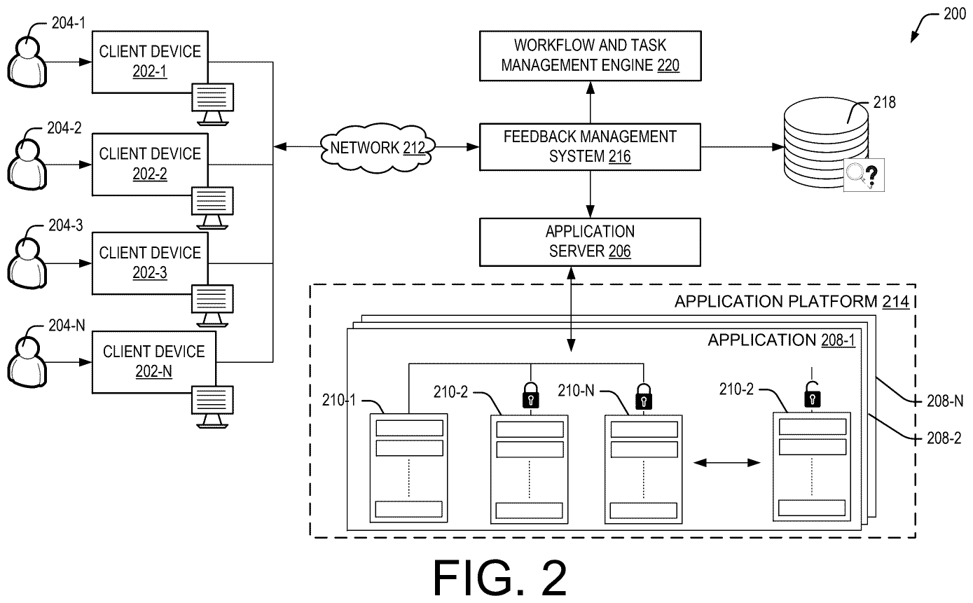

The above aspects in relation to the system 102 are further discussed in detail in relation to FIG. 2. FIG. 2 illustrates an exemplary application environment 200 and various entities involved in such application environment 200. The application environment 200 (referred to as environment 200) may include a plurality of client devices 202-1, 2, . . . , N (collectively referred to as client device(s) 202), operating by a plurality of users 204-1, 2, . . . , N (collectively referred to as user(s) 204), accessing an application. In an example, the accessed application may correspond to an application suite comprising a plurality of applications catering to either same category or different category. Examples of user(s) 204 include, but are not limited to, process owner, fabric administrator, business administrator, approver, department user analyst, review project manager, and quality lead.

The environment 200 further includes an application server 206 which may enable one or more user(s) 204 to access one of a plurality of application 208-1, 208-2, . . . , 208-N (collectively referred to as application(s) 208) which are being hosted on an application platform 214. In an example, one or more user(s) 204 accesses one of the application(s) 208 through a network 212.

In an example, the network 212 may be a private network or a public network and may be implemented as a wired network, a wireless network, or a combination of a wired and wireless network. The network 212 may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

As described above, the application server 206 acts as an intermediary which manages user sessions, maintaining the continuity of interactions, and preserving the state of the user activities. Further, the application server 206 is also responsible for authenticating users, verifying their credentials, and authorizing access to ensure that each user has appropriate permissions to access specific functions of the application(s) 208.

In an example, each of the application(s) 208 includes a plurality of functions which are categorized into different sets based on user roles, subscription level, feature unlocking, customization, etc. As depicted in FIG. 2, the first application 208-1 includes a plurality of sets of functions 210-1, 210-2, . . . , 210-N (collectively referred to as set of function(s) 210). Each user among user(s) 204 has access to variety of sets of function(s) 210 based on their current state. For example, in case of a user in a first state, it may have access to the first set of functions 210-1 and the rest set of functions are not accessible by the user. On accomplishing condition to get upgraded to other set of functions, the current state of the user may be transitioned to an augmented state enabling access to other set of functions, e.g., second set of functions 210-2, as explained later.

The environment 200 may further include a feedback management system 216 which is in communication with the client device(s) 202 and the application server 206. In an example, while conducting a feedback session, the feedback management system 216 (referred to as system 216) provides user(s) 204 with various feedback mechanisms, such as surveys, comment boxes, or interactive prompts, which are seamlessly integrated into the application environment. Once feedback is submitted by the user(s) 204, the system 216 processes and analyzes the responses using techniques such as NLP to identify a meaningful information from the user's response representing patterns, trends, and sentiments of the user. The system 216 may also modify the feedback questions in real-time based on user interaction, ensuring that the presented questions as well as the feedback provided by the user(s) 204 remains relevant and engaging. Furthermore, the system 216 may use the feedback in modification of workflows within the application and prioritization of new tasks enabling developers and stakeholders to take targeted actions based on the recommendations generated from the user's response.

Continuing further, the environment 200 further includes a repository 218 which is in communication with the system 216 to provide access to variety of data for managing the feedback of the user(s) 204. In an example, the repository 218 store a wide variety of questions that are selectively presented on the client device(s) 202 of the user(s) 204 for gathering feedback of the user(s) 204 on the application(s) 208. In an example, the questions in the repository 218 are structured to enable the dynamic selection of questions, ensuring that the feedback process is customized and directly relevant to each user's experience with the application. This customization is achieved by analyzing user-specific data such as their role, usage patterns, and preferences.

In addition to housing a diverse pool of questions, the questions within repository 218 are also organized into categories that correspond to different aspects of the application or user experience. This categorization facilitates the efficient retrieval of questions that are aligned with the specific objectives of the feedback session. In an example, the system 216 may retrieve questions from the repository 218 based on various attributes. For example, as user(s) 204 interact with the feedback session and provide their responses, the system 216 analyzes this input to identify meaningful information representing patterns, trends, and sentiments of the user(s) 204. The insights gained from this analysis are then used to generate a set of response attributes, which serve as a basis for querying the repository 218.

The environment 200 further includes a workflow and task management engine 220 which acts as a central hub for orchestrating and tracking the various tasks and their corresponding workflows within the application(s) 208. It is designed to receive inputs, such as user feedback analysis results in the form of a control instruction and translate these into actionable items. The workflow and task management engine 220 (referred to as management engine 220) manages the automatic modification of existing workflows and creation of new tasks which are to be allocated to relevant development teams or stakeholders for targeted actions. In an example, the management engine 220 also oversees the progress of these tasks, ensuring that they are completed in a timely manner and that any modifications to the application's workflows are implemented effectively.

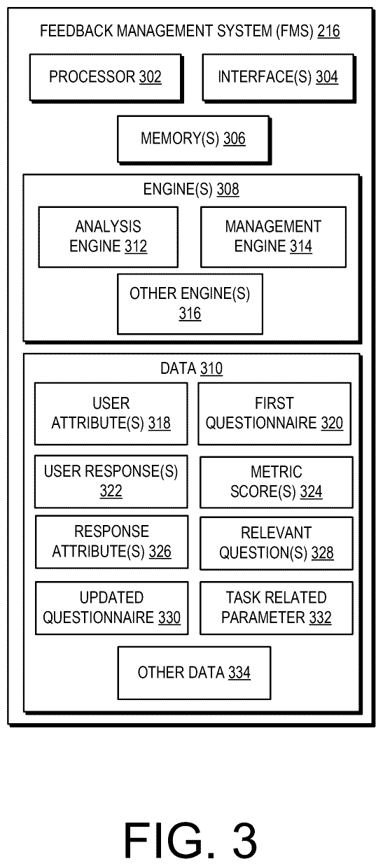

FIG. 3 depicts various functional blocks of the system, as per an example. The system 216 includes a processor 302, interface(s) 304, and memory(s) 306. The processor 302 may be implemented as microprocessors, microcomputers, microcontrollers, digital signal processors, central processing units, state machines, logic circuitries, and/or other devices that manipulate signals based on operational instructions. The interface(s) 304 may allow the connection or coupling of the system 216 with one or more other devices, through a wired (e.g., Local Area Network, i.e., LAN) connection or through a wireless connection (e.g., Bluetooth®, Wi-Fi). The interface(s) 304 may also enable intercommunication between different logical as well as hardware components of the system 216. The interface(s) 304 may also enable the system 216 to communicate with other entities, such as the client device(s) 202, application server 206, repository 218, management engine 220, or other devices or systems.

The memory(s) 306 may be a computer-readable medium, examples of which include volatile memory (e.g., RAM), and/or non-volatile memory (e.g., Erasable Programmable read-only memory, i.e., EPROM, flash memory, etc.). The memory(s) 306 may be an external memory, or internal memory, such as a flash drive, a compact disk drive, an external hard disk drive, or the like. The memory(s) 306 may further include data which either may be utilized or generated during the operation of the system 216.

The system 216 may further include engine(s) 308 and data 310. The engine(s) 308 may be implemented as a combination of hardware and programming, for example, programmable instructions to implement a variety of functionalities of the engine(s) 308. In examples described herein, such combinations of hardware and programming may be implemented in several different ways. For example, the programming for the engine(s) 308 may be executable instructions. Such instructions may be stored on a non-transitory machine-readable storage medium which may be coupled either directly with the system 216 or indirectly (for example, through networked means). In an example, the engine(s) 308 may include a processing resource, for example, either a single processor or a combination of multiple processors, to execute such instructions. In the present examples, the non-transitory machine-readable storage medium may store instructions that, when executed by the processing resource, implement engine(s) 308. In other examples, the engine(s) 308 may be implemented as electronic circuitry.

The engine(s) 308 includes an analysis engine 312 and other engine(s) 316. The other engine(s) 316 may further implement functionalities that supplement functions performed by the system 216 or any of the engine(s) 308. In an example, the engine(s) 308 may also include a management engine 314 (similar to management engine 220 as depicted in FIG. 2) for modifying workflow and creating new task within the application based on the analyzed user's response. It may be noted that the functions of the management engine 314 may be performed by the system 216 itself without requiring any dedicated engine.

The data 310, on the other hand, includes data that is either stored or generated as a result of functions implemented by any of the engine(s) 308 or the system 216. It may be further noted that information stored and available in data 310 may be utilized by the engine(s) 308 for performing various functions to be implemented by the system 216. In an example, data 310 may include user attribute(s) 318, first questionnaire 320, user response(s) 322, metric score(s) 324, response attribute(s) 326, relevant question(s) 328, updated questionnaire 330, task-related parameter 332, and other data 334. It may be noted that such examples of the various functional blocks as depicted in FIG. 3 are indicative. The present approaches may be applicable to other examples without deviating from the scope of the present subject matter.

The working of the system 216 (via functional blocks as depicted in FIG. 3) is explained in conjunction with various elements of the environment 200 (as described in FIG. 2). In operation, any one or more user(s) 204, e.g., user 204-1, may interact through respective client device(s) 202, e.g., client device 202-1, with the first application 208-1 which is being hosted by the application server 206 on the client device 202-1. It may be noted that, though user 204-1 has been described to interact with the first application 208-1, however, the user 204-1 may interact with any of the application(s) 208 which are being hosted within the application platform 214.

Returning to the present example, the analysis engine 312 of the system 216 detects occurrence of a feedback trigger through the client device 202-1. Although the present example is described in relation to the client device 202-1, the present approaches may be performed through any one of the client device(s) 202, without deviating from the scope of the present subject matter. Returning to the present example, the feedback trigger may refer to an event or condition detected by the system 216 that indicates that the user 204-1 on the client device 202-1 has performed an action that warrants the initiation of a feedback session. It may be noted that the action may be a specific interaction of the user 204-1 with the first application 208-1 or reaching a particular milestone within the first application 208-1 that prompts the system 216 to seek user feedback.

When the feedback trigger is detected, the analysis engine 312 transmits a prompt message to the concerned user's client device, i.e., client device 202-1. In an example, this prompt message is the starting point of the feedback session and is designed to engage the user 204-1 in providing feedback about their experiences with the first application 208-1. The prompt message may be a notification, an in-app message, or any other form of communication that effectively reaches the user 204-1 and invites the user 204-1 to participate in the feedback process.

Once the feedback session has been initiated, the analysis engine 312 may generate the first questionnaire 320 to be transmitted to the client device 202-1 of the user 204-1 for obtaining user feedback. In an example, the first questionnaire 320 is comprised of a set of questions which are retrieved from the repository 218. In an example, the set of questions are retrieved based on the first application 208-1 to which the feedback session pertains to. In another example, the question may be selected based on specific user attribute(s) 318. The user attribute(s) 318 may include the details related to the user's role within the application, user's usage pattern, or any other relevant user data that may be pertinent to the application for which the feedback is being provided. In an example, the user attribute(s) 318 may be derived from data stored within the repository 218 or from the application server 206, which may include user profiles, historical interaction logs, frequency of interaction of user with the first application 208-1, and other relevant user information.

Continuing further, the analysis engine 312 transmits the first questionnaire 320 to the user's client device 202-1. When the first questionnaire 320 is presented onto the user's client device 202-1, the user 204-1 interacts with the first application 208-1 and provides responses to the questions received from the system 216. In an example, the user 204-1 provides the response in one of a free-text format or as a selection from multiple-choice options. Once the response is provided by the user 204-1, the analysis engine 312 receives the responses and stores them as user response(s) 322.

Once the user response(s) 322 is received, the analysis engine 312 assigns a metric score, to the user 204-1 for the response provided. In an example, when the user 204-1 answers a first question among the first questionnaire 320, the analysis engine 312 assigns a first metric score to the user 204-1 and stores it in metric score(s) 324. In an example, the metric score(s) 324 that may be allocated may be dependent on the number of questions for which the response may have been provided. Further, the metric score(s) 324 may also be dependent on a weight which is associated with the question that may have been responded to by the user 204-1. In an example, each question of the first questionnaire 320 are associated with a weight based on the relevance or impact of the answered question to one or more functions pertaining to the first application 208-1, category of the question, role of the user 204-1, and patterns detected in the user's current and historical responses. In an example, the metric score(s) 324 that is to be assigned for responding to each question may be provided in a mapping between the weight associated with the question and corresponding metric score for that weight. The mapping may be stored in other data 334.

Continuing further, the analysis engine 312 evaluates the metric score(s) 324 assigned to the user against a plurality of threshold milestones. In an example, the analysis engine 312 compares the metric score(s) 324 assigned to the user 204-1 with plurality of threshold milestones. In one example, the plurality of threshold milestones serves as benchmarks for evaluating the metric score(s) 324 to the user 204-1 based on their feedback.

Based on the comparison, when it is determined that the metric score(s) 324 assigned to the user 204-1 exceeds a threshold milestone of the plurality of threshold milestones, features or functions that are available against the exceeded threshold milestone are enabled for the user 204-1. In an example, as depicted in FIG. 2, if the metric score(s) 324 assigned to the user 204-1 exceeds a first threshold milestone of the plurality of threshold milestones, the analysis engine 312 facilitates the transition of user's profile or account status to an augmented state or status which allows access to the second set of function(s) 210-2 (e.g., depicted as unlocked in FIG. 2) or even provide access to other applications as well which are being hosted in the application platform 214.

It may be noted that, though in FIG. 2, the second set of function(s) 210-2 are depicted as being enabled in addition to the first set of function(s) 210-1, however, any other combination of set of functions may be enabled without deviating from the scope of the present subject matter. In an example, the functions included in the second set of function(s) 210-2 are different from the functions included in the first set of function(s) 210-1 reflecting an increase in number of available features, enhanced capabilities of the existing features, or accessibility to various functions provided by the first application 208-1.

Returning to the present example, to facilitate such transition of user's state from the current state to the augmented state, the system 216 communicates with the application server 206. In an example, when the user 204-1 acquires a sufficient number of metric score(s) 324, the analysis engine 312 triggers an access request which is to be transmitted to the application server 206. In an example, the access request encapsulates the user's credentials and the metric score(s) 324 of the user 204-1, serving as a digital assertion of the user's eligibility for augmented features within the first application 208-1.

Upon receiving the access request, the application server 206 performs a verification process to examine the legitimacy of the metric score(s) 324 of the user 204-1, cross-references the user's identity with the application's records, and ensures that the request adheres to the established protocols for user state transitions. Upon successful validation, the application server 206 upgrade or transitions the user's state within the first application 208-1. The application server 206 may facilitate this upgrade through other methods (e.g., by way of tokens generated by the analysis engine 312) without deviating from the scope of the present subject matter. For example, in the context of token-based access, the application server 206 issues a digital token to the user 204-1 in response to successful validation of the access request for state transition. In an example, the digital token may be a cryptographic representation of additional access rights for one or more functions of the first application 208-1. The digital token containing cryptographic representation may then be presented to the first application 208-1 interface to make accessibility of previously restricted new features, services, or application(s) 208 within the application platform 214.

It may be noted that, as user 204-1 provide feedback and accumulate metric score(s) 324, they may be in a position to access additional features, functionalities, or even applications, that were otherwise not available to the user 204-1 previously. Such approaches, as may be noted, motivate users to participate in the feedback process.

It is pertinent to note that for capturing nuanced feedback that reflects the diverse experiences of user(s) 204, it is important to modify the questionnaire in real-time based on individual responses provided by the user 204-1 to ensure the relevance and effectiveness of the feedback mechanism. To this end, the analysis engine 312 may analyze the user response(s) 322 and accordingly effect modification of questions in the previously presented questionnaire.

The pre-processing relating to modification of questionnaire entails the analysis engine 312 parsing the user response(s) 322 to identify and remove elements from the user response(s) 322 which are non-relevant to obtain a parsed user's response. In an example, the non-relevant elements which are present within the user response(s) 322 may be determined based on predefined rules or based on predefined terms and/or phrases defined in a list. For example, the predefined rules, phrases, and/or terms may be such so as to assist in determining non-relevant terms within the user response(s) 322. For multiple-choice responses, preprocessing might involve converting responses into standardized codes for easier aggregation and analysis. Collectively, these preprocessing steps are designed to refine the user's response, setting the stage for more effective and accurate analysis using techniques such as natural language processing.

Continuing further, once the non-relevant elements are removed and the parsed user's response is obtained, the analysis engine 312 then analyzes the parsed user's response to extract meaningful information. In an example, the parsed user's response is then analyzed to get deeper understanding of the response, such as detecting patterns, trends, or sentiments of the user 204-1. In an example, the analysis engine 312 may analyze the received user response(s) 322 by comparing them with exemplary responses stored in the repository 218, to determine the response attribute(s) 326. In an example, the repository 218 may store a plurality of exemplary responses with corresponding response attribute(s) 326 annotated with each exemplary response. Therefore, based on comparison of the user response with the exemplary responses, the analysis engine 312 determines the set of response attribute(s) 326.

It may be noted that, in case user has answered first question of the first questionnaire, the analysis engine 312 may determine the sentiment of the user 204-1 but it may be unable to identify the pattern and trends in user response as there is only one response for the first question. To this end, in an example, to get an idea regarding the patterns and trends in the user response(s) 322, the analysis engine 312 may also analyze the previous or historical responses of the same user 204-1, which have been obtained during past feedback sessions.

Once the response attribute(s) 326 are determined, the analysis engine 312 executes a search query based on the response attributes on the repository 218. In an example, this search query is designed to retrieve from the repository 218 a set of relevant question and store them as relevant question(s) 328 that are pertinent to the attributes identified. For example, if the user's feedback indicates issues with a particular feature of the application, the search query may aim to find questions related to that feature or similar issues.

Upon identifying the relevant question(s) 328, the analysis engine 312 of the system 216 is to modify the first questionnaire 320 to generate the updated questionnaire 330. The updated questionnaire 330 may thereafter be transmitted to the client device 202-1 of the user 204-1.

Modification of the first questionnaire 320 may entail different actions. In an example, the analysis engine 312 may reorder the sequence of questions provided in the first questionnaire 320. The reordering is based on the relevance of each question to the user's previously provided feedback. For example, if the user 204-1 has indicated a particular issue or interest in a specific aspect of the first application 208-1, questions related to the specific issue (which may have been listed later in the first questionnaire 320) are moved up the list to be presented next to the user 204-1, in the updated questionnaire 330. This prioritization ensures that the user's immediate inputs pertaining to the issue or concern are captured without delay.

In an example, the analysis engine 312 may also introduce new questions into the first questionnaire 320, replace or even modify existing questions in the first questionnaire 320. For instance, if a user's feedback suggests confusion about a new feature, the system 216 might add questions that explore the user's understanding and experiences with that feature in greater depth. This may provide the developers with more granular insights into user experiences and potential areas for improvement.

Conversely, the analysis engine 312 may also remove questions that may have become less relevant in light of the user's responses that may have been provided already. For example, if the user's feedback indicates that they have no experience with or opinion on a particular feature, subsequent questions about that feature might be deemed unnecessary and thus removed from the questionnaire. This streamlining of the questionnaire prevents user fatigue and maintains focus on obtaining valuable feedback.

As may be noted from the above examples, the system 216 dynamically and responsively modifies the first questionnaire 320. As the user 204-1 provides their inputs, the system 216 may further modify the questionnaire in real time, ensuring that each question presented is pertinent. This adaptive feedback mechanism fosters a more interactive and user-centric experience, encouraging users to continue providing feedback and thereby contributing to the application's ongoing improvement and development.

The gathered feedback may be used to implement or modify existing workflows corresponding to tasks within the first application 208-1. In an example, on reception of every response from the client device 202-1, the analysis engine 312 determines a task-related parameter which corresponds to a potential task for modifying an existing workflow of the application, based on user's response(s) 322.

As may be understood, workflows are integral to the operation of an application as they define how data is processed, how tasks are executed, and how different components of the application (or the application itself) operate to ensure performant functioning of the application platform. In an example, the analysis engine 312 modifies the workflows based on user response or feedback provided by the user regarding the first application 208-1. To this end, the analysis engine 312 analyzes the user's response(s) 322, to discern underlying patterns, trends, and sentiments behind that user's response(s) 322.

Upon deriving meaningful insights indicating requirements of the user from the user response(s) 322, the analysis engine 312 determine the task-related parameter 332. The task-related parameter 332 corresponds to a potential task having a workflow which is to be modified within the first application 208-1 as per the user's requirement. The task-related parameter 332 is indicative of the nature or scope of the proposed modification, providing a clear and actionable directive for enhancing the first application 208-1 in alignment with user feedback. For example, if the analysis reveals that users find a particular feature cumbersome, the task-related parameter 332 related to a task aimed at simplifying the user interface for that feature is determined. Alternatively, if users suggest the addition of a new capability, the task-related parameter 332 may outline the development of this new function within the application's workflow.

Once the task-related parameter 332 is determined, the analysis engine 312 is to identify an existing workflow within the first application 208-1 that corresponds to the determined task-related parameter 332. In an example, the existing workflow is the target workflow which is to be modified. This involves identifying the existing workflow using a mapping between the task-related parameter 332 (which encapsulates the nature or scope of the desired modification) and a particular sequence of operations or set of functions that are part of the application's existing workflows.

Once the relevant workflow is identified, the analysis engine 312 proceeds and generates one or more control instructions to be transmitted to the management engine 314 (or to management engine 220 via network 212) to modify the identified workflow. The analysis engine 312 has to ensure that the identified workflow is the correct target workflow for the modifications suggested by the user feedback. This precision in identification is paramount to effectively addressing the user's concerns and enhancing the application in a way that is meaningful and impactful.

On the other hand, if the analysis engine 312 fails to identify an existing workflow within the first application 208-1 that corresponds to the determined task-related parameter 332, an alternative course of action is initiated, i.e., instead of modifying an existing workflow, the analysis engine 312 is to communicate with the management engine 220 to facilitate the creation of a new task. In an example, such new task is not arbitrary, rather it is specifically formulated based on the patterns, trends, and sentiments detected in the user's feedback.

It may be noted that, although the description of FIG. 2-3 is provided with respect to the user 204-1 and the client device 202-1, it is to be understood that the described system 216 may be implemented with any other user and client device without limitation. The principles and functionalities of the system 216 are designed to be universally applicable across various users and corresponding client devices, ensuring that the feedback management and user state transition processes are scalable and adaptable to different user profiles and device configurations. This allows for a broad application of the system 216 within diverse environments and user ecosystems, maintaining the integrity and effectiveness of the feedback mechanism regardless of the specific user or client device in question.

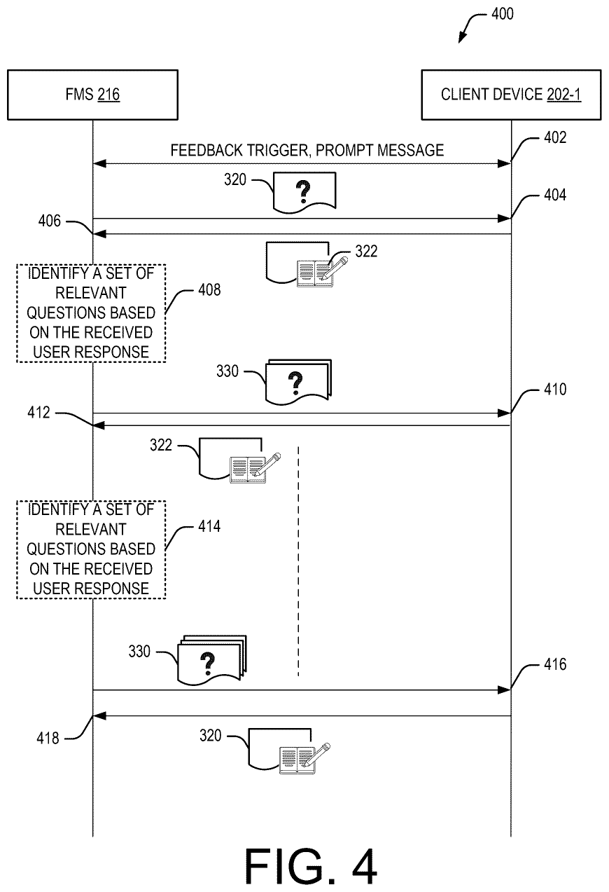

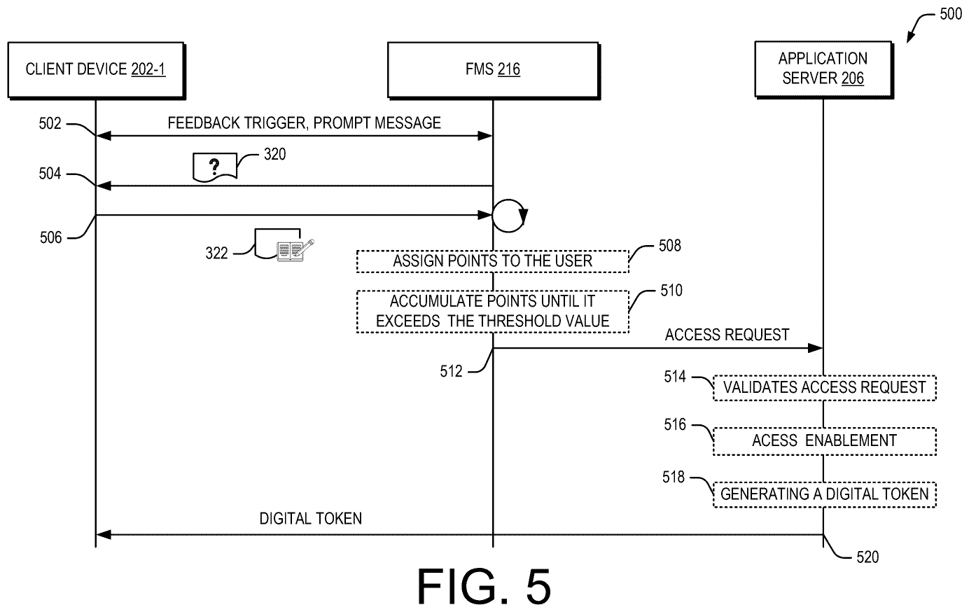

The above approaches are further explained in conjunction with exemplary call flow diagrams as illustrated in FIGS. 4-5. FIG. 4 illustrates an example call flow diagram 400 representing communication between various computational entities of an application environment, as per one example. The present explanation is provided with reference to the environment 200.

As described previously, a user, such as user 204-1, engages with an application, e.g., first application 208-1, using a client device, such as client device 202-1, which may range from a desktop computer to a mobile phone, to access and utilize the first application's 208-1 features. To enhance the user experience and continuously improve the application, a feedback management system, such as system 216, is integrated into the environment 200. This system 216 is in communication with the client device 202-1, enabling it to solicit user feedback actively. As the user interacts with the first application 208-1, the system 216 captures their input and experiences as feedback. This feedback is then used for various objectives, such as modifying subsequent questions presented to the user, ensuring that the feedback process is dynamic and tailored to the user's role and interaction with the first application 208-1.

When the user 204-1 interacts on the client device 202-1, the system 216 monitors the client device 202-1 to detect a feedback trigger (as indicated by step 402) and subsequently transmits a prompt message to the client device 202-1 to initiate a feedback session. In an example, the feedback trigger is an event or condition detected by the system 216 indicating that the user 204-1 operating on client device 202-1 has performed an action that warrants the initiation of the feedback session. It may be noted that, the action may be a specific interaction of the user 204-1 with the application or reaching a particular milestone within the first application 208-1 that prompts the system 216 to seek user feedback.

Once the feedback session has been initiated, the system 216 may communicates with client device 202-1 to transmit the first questionnaire 320 to the client device 202-1 (as indicated by step 404). In an example, the analysis engine 312 interacts with the repository 218 to extract a set of questions to form the first questionnaire 320. In an example, the first questionnaire 320 is composed of questions that are relevant to the application and the user's experience within it. As described above as well, the selection of these questions is based on specific user attribute(s) 318. The user attribute(s) 318 may include the details related to the user's role within the application, user's usage pattern, preferences, or any other relevant user data that may customize the feedback experience.

Upon receiving the first questionnaire 320, the user 204-1 may interact with the first questionnaire 320 on client device 202-1 and provide feedback in the form of responses to the questions present in the questionnaire. In an example, the user 204-1 provides the response in one of a free-text format or as a selection from multiple-choice options. The user response(s) 322 thus received by the client device 202-1 is then transmitted in real-time to the system 216 (as indicated by step 406).

On receiving the user response(s) 322, the system 216 initiates a series of steps to process and utilize the user response(s) 322 effectively. Initially, the system 216 performs parsing of the user response(s) 322, which involves identifying and removing non-relevant components, thereby segregating the relevant components of the user response(s) 322 for further analysis. The system 216 then analyzes the relevant components of the user response(s) 322 using advanced techniques, such as NLP, to identify response attribute(s) 326 indicating underlying patterns, trends, and sentiments expressed by the user 204-1 in their responses. Based on the response attribute(s) 326, system 216 executes a search query within the repository 218 to identify and extract the set of relevant question(s) 328 that are particularly relevant to the user's feedback (as depicted by step 408).

Upon successful extraction of the relevant question(s) 328, the system 216 modifies the order and content of the questions in the first questionnaire 320, dynamically adjusting it in real-time to reflect the user's input, thereby creating the updated questionnaire 330, which may provide a more engaging feedback experience for the user 204-1 and transmit the same to the client device 202-1 (as indicated by step 410). In response, the client device 202-1 receives the updated questionnaire 330 and promptly presents the revised questionnaire, i.e., the updated questionnaire 330, reflecting the iterative feedback and analysis process to the user 204-1 (as indicated by step 412).

As the user 204-1 continues to provide feedback for subsequent questions, this cycle of receiving a user response, analyzing it, and refining the questionnaire is repeated, thereby creating a feedback loop that is continuously evolving and adapting to the user's engagement with the first application 208-1. This iterative process provides a more interactive and personalized feedback loop, which is central to enhancing user satisfaction and improving the application based on user-driven insights (as indicated by step 414-418).

FIG. 5 illustrates an example call flow diagram 500 representing communication between various computational entities of an application environment, as per one example. The present explanation is provided with reference to the environment 200. Similar to the call flow diagram as depicted in FIG. 4, the user 204-1 operates the client device 202-1 to access the one of the applications, e.g., the first application 208-1, which is being hosted on the application platform 214 by the application server 206. The objective of the system 216 is to enhance user engagement by providing a dynamic feedback mechanism that not merely collects user input but also uses it to upgrade the user's state within the first application 208-1.

To this end, as the user interacts with the first application 208-1 and provides feedback, the system 216 processes this information to facilitate transition of the current state of the user 204-1 to the augmented state, thereby unlocking additional features, capabilities, or access levels that provides enhanced user's experience and encourages user for continued and meaningful participation in the feedback process.

The description of steps 502-506 is similar to that of steps 402-406 as described in conjunction with FIG. 4. At step 506, the system 216 receives the user response(s) 322 from the client device 202-1. Once received, the analysis engine 312 assigns a quantifiable value, or metric score, to the user 204-1. In an example, when the user 204-1 answers the first question among the first questionnaire 320, the analysis engine 312 assigns a first metric score to the user 204-1 (as indicated by step 508). It may be noted that, as described previously, this assignment of score is based on a predetermined weight associated with each question, which reflects the question's relevance or potential impact on the application's enhancement.

In an example, the analysis engine 312 accesses the other data 334 in the system 216 to determine the appropriate number of metric scores to be assigned to the user 204-1 as the other data 334 stores a score-weight mapping. It may be noted that, this process of assigning metric scores is integral to incentivizing user participation and engagement with the system 216. It encourages users to provide thoughtful and valuable feedback, knowing that their contributions may lead to access to advanced features or services within the first application 208-1 or even access to other applications hosted by the application platform 214.

Once the metric score(s) 324 is assigned, the system 216 evaluates the assigned metric score(s) 324 against the plurality of threshold milestones which may be stored within the other data 334. In an example, the analysis engine 312 compares the metric score(s) 324 with the plurality of threshold milestones. In one example, as described above as well, the plurality of threshold milestones serves as benchmarks for evaluating the metric score(s) 324 which is assigned to the user 204-1 based on their feedback.

With each question answered, the analysis engine 312 assigns the metric score and accumulates with the previously assigned metric score(s) 324 (as indicated by step 510). In an example, based on the comparison, when it is determined that the assigned metric score(s) 324 does not exceeds one of the threshold milestones of the plurality of threshold milestones, the analysis engine 312 continue to receive user responses for subsequent questions and assign a metric score to the user 204-1 based on the weight associated with the subsequent question (as indicated by loop present at step 506).

On the other hand, when it is determined that the assigned metric score(s) 324 exceeds one of the threshold milestones of the plurality of threshold milestones, the analysis engine 312 facilitates the transition of user's profile or account state to reflect new state which allows access to a second set of functions. To this end, the system 216 communicates with the application server 206 to effectuate the transition of user state. In an example, when the user 204-1 acquires a sufficient number of metric scores, the system 216 triggers an access request which is to be transmitted to the application server 206 (as indicated by step 512). In an example, the access request encapsulates the user's credentials and the assigned metric score(s) 324, serving as a digital assertion of the user's eligibility for enhanced application privileges.

Upon triggering of access request, the application server 206 receives this access request and initiates a verification process to validate the access request (as indicated by step 514). In an example, the application server 206 examines the legitimacy of the metric score(s) 324, cross-references the user's identity with the application's records, and ensures that the request adheres to the established protocols for user state transitions. This step is instrumental in preventing unauthorized access and preserving the application's operational integrity.

Upon successful validation, the application server 206 transitions the current state of user 204-1 to the augmented state, thereby enhancing the features or services of the first application 208-1 or even provide access to other application(s) 208 (as indicated by step 516). In an example, the application server 206 may facilitate this upgrade through other methods, such as token-based enablement method.

In one example, in the token-based enablement method, the application server 206 generates and issues a digital token to the user 204-1 or client device 202-1, which serves as a cryptographic representation of their additional access rights. The user 204-1 may then present this token within the first application 208-1 to gain entry to previously restricted areas or to activate new features and services (as indicated by steps 518-520). This token acts as a secure and temporary credential that may be designed to expire or update as the user 204-1 continues to interact with the first application 208-1.

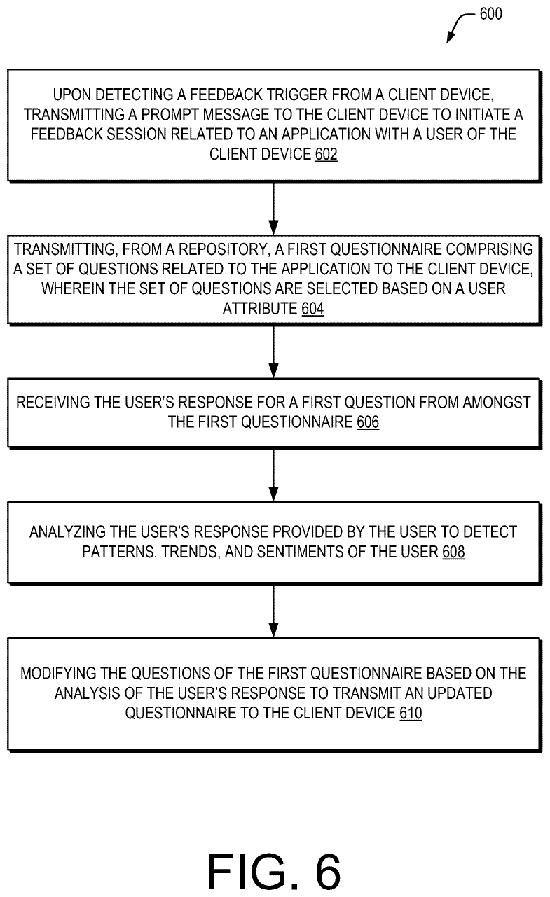

FIG. 6 illustrates a method 600 for managing and analyzing user feedback, as per an example. The order in which the above-mentioned method is described is not intended to be construed as a limitation, and some of the described method blocks may be combined in a different order to implement the method, or an alternative method.

Furthermore, the above-mentioned method may be implemented in suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a feedback management system, such as system 216. In an implementation, the method may be performed under an “as a service” delivery model, where the system 216, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 600 may be implemented by the system 216 for analyzing the user responses received for one or more questions among the questionnaires. The present method 600 is explained from the perspective of a first question being answered, wherein the first question is part of the first questionnaire. Although the present explanation is provided in relation to the first question, these approaches may also be applicable for any of the questions being answered from the first questionnaire 320. Such implementations too would fall within the scope of the present subject matter.

At block 602, a prompt message is transmitted to a client device to initiate a feedback session on detecting a feedback trigger from the client device. For example, the analysis engine 312 of the system 216 detects occurrence of a feedback trigger through the client device 202-1. In an example, the feedback trigger may refer to an event or condition detected by the system 216 that indicates that the user 204-1 on the client device 202-1 has performed an action that warrants the initiation of a feedback session. It may be noted that, the action may be a specific interaction of the user 204-1 with the application or reaching a particular milestone within the application that prompts the system 216 to seek user feedback.

When the feedback trigger is detected, the analysis engine 312 transmits the prompt message to the concerned user's client device, i.e., client device 202-1. In an example, this prompt message is the starting point of the feedback session and is designed to engage the user 204-1 in providing feedback about their experiences with the first application 208-1.

At block 604, a first questionnaire including a set of questions related to the application is transmitted to client device from a repository. For example, the analysis engine 312 may generate the first questionnaire 320 to be transmitted to the client device 202-1 of the user 204-1 for obtaining user feedback. In an example, the first questionnaire 320 is comprised of set of questions which are retrieved from the repository 218. In an example, the set of questions are retrieved based on the application to which the feedback session pertains to, i.e., the first application 208-1 in present case. In another example, the questions may be selected based on specific user attribute(s) 318. The user attribute(s) 318 may include the details related to the user's role within the application, user's usage pattern, or any other relevant user data that may be pertinent to the application for which the feedback is being provided, i.e., the first application 208-1. Thereafter, the analysis engine 312 transmits the first questionnaire 320 to the user's client device 202-1.

At block 606, user's response for a first question from amongst the first questionnaire is received. For example, when the first questionnaire 320 is presented onto the user's client device 202-1, the user 204-1 interacts with the application and provides responses to the questions received from the system 216. In an example, the user 204-1 provides the response in one of a free-text format or as a selection from multiple-choice options. Once the response is provided by the user 204-1, the analysis engine 312 receives the user response(s) 322.

At block 608, the user's response provided by the user is analyzed to detect patterns, trends, and sentiments of the user. For example, the analysis engine 312 then analyzes the response to extract meaningful information. In an example, the user response(s) 322 is analyzed to get deeper understanding of the response, such as detecting patterns, trends, or sentiments of the user 204-1. In an example, the analysis engine 312 may analyze the received user response(s) 322 by comparing it with exemplary responses stored in the repository 218 to get an idea of meaning behind the response.

It may be noted that, since the user 204-1 has just answered first question of the first questionnaire, the analysis engine 312 may be able determine the sentiment of the user 204-1 but it may not be able to identify the pattern and trends in user response as there is only one response received for the first question. To this end, in an example, to get an idea regarding the patterns and trends in the user response(s) 322, the analysis engine 312 may also analyze the previous or historical responses of the same user 204-1, which have been obtained during past feedback sessions.

At block 610, the questions of the first questionnaire are modified based on the analysis of the user's response to transmit an updated questionnaire to the client device. For example, the analysis engine 312 modifies the first questionnaire 320 based on the understanding obtained by analyzing the user response(s) 322 to generate the updated questionnaire 330. The updated questionnaire 330 may thereafter be transmitted to the client device 202-1 of the user 204-1.

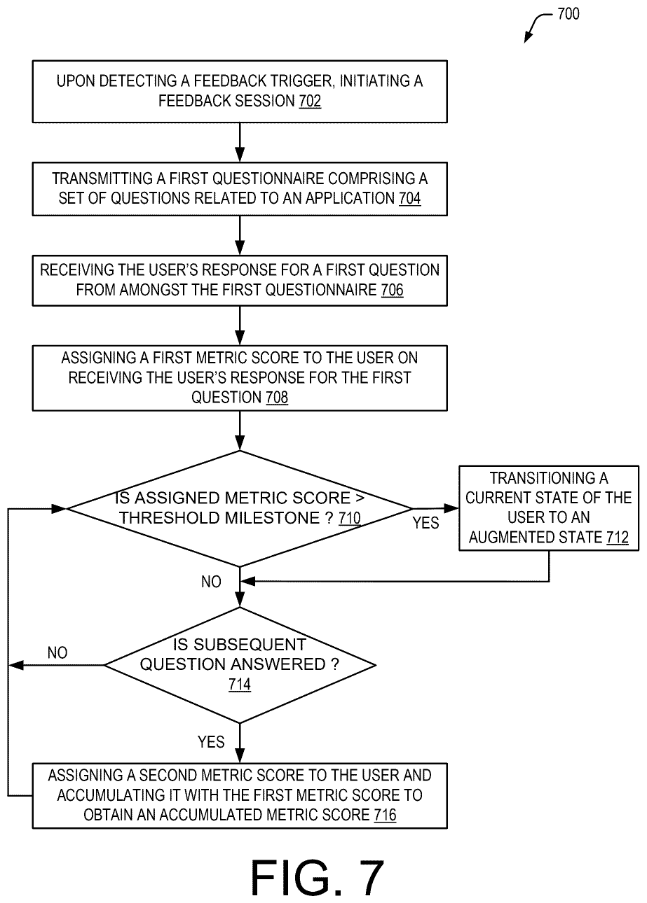

FIG. 7 illustrates a method 700 for implementing incentive-driven feedback mechanism, as per an example. The order in which the above-mentioned method is described is not intended to be construed as a limitation, and some of the described method blocks may be combined in a different order to implement the method, or an alternative method.

Furthermore, the above-mentioned method may be implemented in suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a feedback management system, such as system 216. In an implementation, the method may be performed under an “as a service” delivery model, where the system 216, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

At block 702, a feedback session is initiated on detecting a feedback trigger from a client device. For example, the analysis engine 312 detects occurrence of a feedback trigger through the client device 202-1. In an example, the feedback trigger may refer to an event or condition detected by the system 216 that indicates that the user 204-1 on the client device 202-1 has performed an action that warrants the initiation of a feedback session. It may be noted that, the action may be a specific interaction of the user 204-1 with the application or reaching a particular milestone within the application that prompts the system 216 to seek user feedback.

When the feedback trigger is detected, the analysis engine 312 transmits the prompt message to the concerned user's client device, i.e., client device 202-1. In an example, this prompt message is the starting point of the feedback session and is designed to engage the user 204-1 in providing feedback about their experiences with the first application 208-1.

At block 704, a first questionnaire including a set of questions related to an application is transmitted. For example, the analysis engine 312 may generate the first questionnaire 320 to be transmitted to the client device 202-1 of the user 204-1 for obtaining user feedback. In an example, the first questionnaire 320 is comprised of set of questions which are retrieved from the repository 218. In an example, the set of questions are retrieved based on the application to which the feedback session pertains to, e.g., first application 208-1 in the present case. In another example, the question may be selected based on specific user attribute(s) 318. The user attribute(s) 318 may include the details related to the user's role within the application, user's usage pattern, or any other relevant user data that may be pertinent to the application for which the feedback is being provided. Thereafter, the analysis engine 312 transmits the first questionnaire 320 to the user's client device 202-1.

At block 706, user's response for a first question from amongst the first questionnaire is received. For example, when the first questionnaire 320 is presented onto the user's client device 202-1, the user 204-1 interacts with the application and provides responses to the questions received from the system 216. In an example, the user 204-1 provides the response in one of a free-text format or as a selection from multiple-choice options. Once the response is provided by the user 204-1, the analysis engine 312 receives the user response(s) 322.

At block 708, a first metric score is assigned to the user on receiving the user's response for the first question. For example, the analysis engine 312 assigns a metric score to the user 204-1 for the response provided. In an example, when the user 204-1 answers a first question among the first questionnaire 320, the analysis engine 312 assigns a first metric score to the user 204-1 and store it as metric score(s) 324. In an example, the metric score(s) 324 that may be allocated may be dependent on the number of questions for which the response may have been provided. Further, the metric score(s) 324 may also be dependent on a weight associated with the question that may have been responded to by the user 204-1. In an example, each question of the first questionnaire 320 are associated with a weight based on the relevance or impact of the answered question to one or more functions pertaining to the first application 208-1, category of the question, role of the user 204-1, and patterns detected in the user's current and historical responses. In an example, the metric score(s) 324 that is to be assigned for responding to each question may be provided in a mapping between the weight associated with the question and corresponding metric score for that weight. The mapping may be stored in other data 334.

At block 710, a determination is made to check whether the assigned metric score has exceeded a threshold milestone. For example, the analysis engine 312 evaluates the metric score(s) 324 assigned to the user against the plurality of threshold milestones to determine whether the metric score(s) 324 has exceeded the threshold milestones. In an example, the analysis engine 312 compares the metric score(s) 324 assigned to the user 204-1 with plurality of threshold milestones. In one example, the plurality of threshold milestones serves as benchmarks for evaluating the metric score(s) 324 to the user 204-1 based on their feedback.

Based on the comparison, when it is determined that the metric score(s) 324 assigned to the user 204-1 exceeds one of the threshold milestones of the plurality of threshold milestones, the method proceeds to block 712 (‘Yes’ path from block 710). On the other hand, when it is determined that the metric score(s) 324 assigned to the user 204-1 does not exceed one of the threshold milestones of the plurality of threshold milestones, the method proceeds to block 714 (‘No’ path from block 710).

At block 712, a current state of the user is transitioned to an augmented state. In an example, the transition to augmented state indicates enablement of enhanced features or services of the application to the user. For example, if the metric score(s) 324 assigned to the user 204-1 exceeds a first threshold milestone of the plurality of threshold milestones, the analysis engine 312 facilitates the transition of user's profile or account status to an augmented state or status which allows access to the second set of function(s) 210-2 (depicted as unlocked in FIG. 2) or even provide access to other applications as well which are being hosted in the application platform 214. Once the transition of user state has been performed, the method proceeds to block 714 to check reception of responses for subsequent questions of the first questionnaire 320.

At block 714, a determination is made to check whether a subsequent question has been answered. For example, the analysis engine 312 continuously monitors the reception of user response from the client device 202-1. On detecting that a subsequent question from the first questionnaire 320 has been answered, the method proceeds to block 716 to assign a second metric score to user 204-1 (‘Yes’ path from block 714). On the other hand, based on monitoring, if no subsequent question has been detected as answered, the method proceeds to block 710.

At block 716, a second metric score is assigned to the user and accumulated with the first metric score to obtain an accumulated metric score. For example, the analysis engine 312 assigs a second metric score to the user 204-1 and accumulates it with the first metric score to obtain an accumulated metric score which is stored in metric score(s) 324. Once the accumulated metric score is obtained, the method proceeds back to block 710 to check whether the metric score(s) has exceeded the threshold milestones to enable further transition of state of the user 204-1. It may be noted that, this process of assigning metric score and then augmented state based on the assigned metric score continues with each question answered in the similar manner as described above.

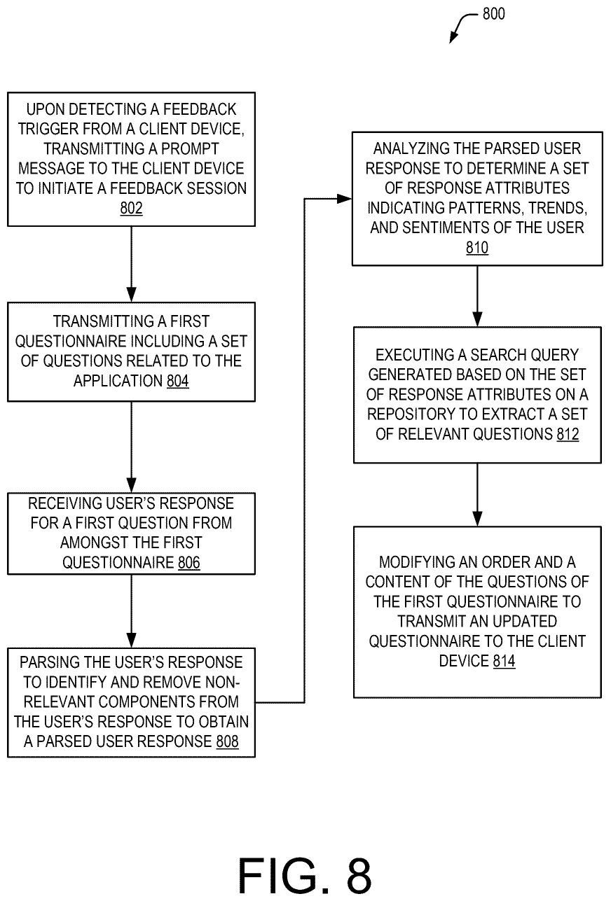

FIG. 8 illustrates a detailed method 800 for managing and analyzing user feedback, as per an example. The order in which the above-mentioned method is described is not intended to be construed as a limitation, and some of the described method blocks may be combined in a different order to implement the method, or an alternative method.

Furthermore, the above-mentioned method may be implemented in suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a feedback management system, such as system 216. In an implementation, the method may be performed under an “as a service” delivery model, where the system 216, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

The description of blocks 802-806 is similar to description of blocks 602-606. Hence, the same is not provided here for the sake of brevity.

At block 808, the user response is parsed to identify and remove non-relevant components from the user's response to obtain a parsed user response. In an example, the user response received from client device 202-1 may include both relevant as well as non-relevant information. To get the non-relevant components removed, the user response(s) 322 is parsed. For example, the analysis engine 312 parses the user response(s) 322 to identify and remove elements from the user response(s) 322 which are non-relevant to obtain a parsed user's response. In an example, the non-relevant elements which are present within the user response(s) 322 may be determined based on predefined rules or based on predefined terms and/or phrases defined in a list. For example, the predefined rules, phrases, and/or terms may be such so as to assist in determining non-relevant terms within the user response(s) 322. For multiple-choice responses, preprocessing might involve converting responses into standardized codes for easier aggregation and analysis. Collectively, these preprocessing steps are designed to refine the user's response, setting the stage for more effective and accurate analysis using techniques such as natural language processing.

At block 810, the parsed user response is analyzed to determine a set of response attributes indicating patterns, trends, and sentiments of the user. In an example, to get the questions of the questionnaire changed, new questions are identified based on the response provided by user and to get these questions, a set of response attributes are determined indicating characteristics features of the user response(s) 322 to query the repository. For example, the analysis engine 312 analyzes the response to extract meaningful information. In an example, the parsed user's response is then analyzed to get deeper understanding of the response, such as detecting patterns, trends, or sentiments of the user 204-1. In an example, the analysis engine 312 may analyze the received user response(s) 322 by comparing them with exemplary responses stored in the repository 218, to determine the response attribute(s) 326. In an example, the repository 218 may store a plurality of exemplary response with corresponding response attribute(s) 326 annotated. Therefore, based on comparison of the user response with the exemplary responses, the analysis engine 312 determines the set of response attribute(s) 326.

At block 812, a search query which is generated based on the set of response attributes is executed on the repository to extract a set of relevant questions. For example, the analysis engine 312 executes a search query based on the response attributes on the repository 218. In an example, this search query is designed to retrieve from the repository 218 a set of relevant question and store them as relevant question(s) 328 that are pertinent to the attributes identified. For example, if the user's feedback indicates issues with a particular feature of the application, the search query may aim to find questions related to that feature or similar issues.

At block 814, the order and content of the questions of the first questionnaire is modified to transmit an updated questionnaire to the client device. For example, the analysis engine 312 of the system 216 is to modify the first questionnaire 320 to generate the updated questionnaire 330. The updated questionnaire 330 may thereafter be transmitted to the client device 202-1 of the user 204-1. Modification of the first questionnaire 320 may entail different actions, like changing the order of existing questions of the first questionnaire, adding new questions, and removing existing questions from the first questionnaire.

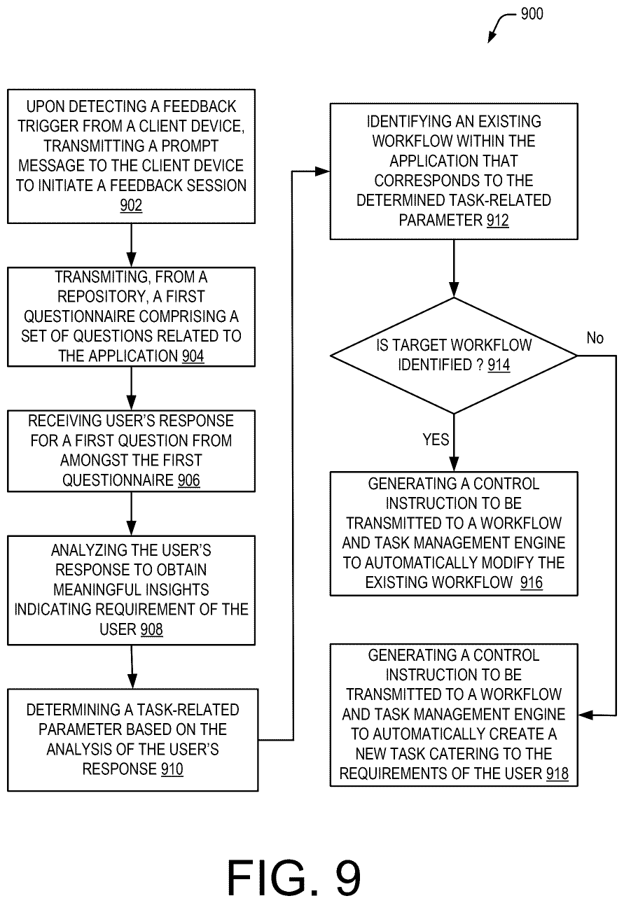

FIG. 9 illustrates a method 900 for managing and analyzing user feedback, as per an example. The order in which the above-mentioned method is described is not intended to be construed as a limitation, and some of the described method blocks may be combined in a different order to implement the method, or an alternative method.

Furthermore, the above-mentioned method may be implemented in suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a feedback management system, such as system 216. In an implementation, the method may be performed under an “as a service” delivery model, where the system 216, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

At block 902, a feedback session is initiated on detecting a feedback trigger from a client device. For example, the analysis engine 312 of the system 216 detects occurrence of a feedback trigger through the client device 202-1. In an example, the feedback trigger may refer to an event or condition detected by the system 216 that indicates that the user 204-1 on the client device 202-1 has performed an action that warrants the initiation of a feedback session. It may be noted that, the action may be a specific interaction of the user 204-1 with the application or reaching a particular milestone within the application that prompts the system 216 to seek user feedback.

When the feedback trigger is detected, the analysis engine 312 transmits the prompt message to the concerned user's client device, i.e., client device 202-1. In an example, this prompt message is the starting point of the feedback session and is designed to engage the user 204-1 in providing feedback about their experiences with the first application 208-1.

At block 904, a first questionnaire including a set of questions related to an application is transmitted. For example, the analysis engine 312 may generate the first questionnaire 320 to be transmitted to the client device 202-1 of the user 204-1 for obtaining user feedback. In an example, the first questionnaire 320 is comprised of set of questions which are retrieved from the repository 218. In an example, the set of questions are retrieved based on the application to which the feedback session pertains to. In another example, the question may be selected based on specific user attribute(s) 318. The user attribute(s) 318 may include the details related to the user's role within the application, user's usage pattern, or any other relevant user data that may be pertinent to the application for which the feedback is being provided. Thereafter, the analysis engine 312 transmits the first questionnaire 320 to the user's client device 202-1.

At block 906, user's response for a first question from amongst the first questionnaire is received. For example, when the first questionnaire 320 is presented onto the user's client device 202-1, the user 204-1 interacts with the application and provides responses to the questions received from the system 216. In an example, the user 204-1 provides the response in one of a free-text format or as a selection from multiple-choice options. Once the response is provided by the user 204-1, the analysis engine 312 receives the user response(s) 322.

At block 908, the user's response is analyzed to obtain a meaningful insight representing the requirement or experience of the user related to the application. In an example, the meaningful insight or the requirement obtained by analyzing user's response indicate what changes does user wants to bring in the application. For example, the analysis engine 312 analyzes the user response(s) 322 provided by the user 204-1 for the first question to obtain meaningful insights representing requirement of the user 204-1. In an example, the meaning insights indicates patterns, trends, and sentiments of the user 204-1 in the user response(s) 322 or with respect to historical user responses received during earlier feedback sessions. In an example, the processor(s) 1002 is to perform in-depth analysis of the user response(s) 322, by utilizing techniques such as NLP and machine learning to discern meaningful insights from the user response(s) 322. This analysis aims to extract actionable insights that reflect the user's experience and expectations regarding the application's functionality and performance.

At block 910, a task-related parameter is determined based on the analysis of the user's response. For example, upon deriving meaningful insights from the user response(s) 322, the analysis engine 312 is to determine the task-related parameter 332. In an example, this task-related parameter 332 corresponds to a potential task for modifying an existing workflow of the first application 208-1. In an example, the task-related parameter 332 is indicative of the nature or scope of the proposed modification, providing a clear and actionable directive for modifying the first application 208-1 in alignment with user feedback. For example, if the analysis reveals that users find a particular feature cumbersome, the task-related parameter 332 may define a task aimed at simplifying the user interface for that feature. Alternatively, if users suggest the addition of a new capability, the task-related parameter 332 may outline the development of this new function within the application's workflow.

At block 912, an existing workflow within the application is identified that corresponds to the determined task-related parameter. For example, the analysis engine 312 is to identify an existing workflow within the first application 208-1 that corresponds to the determined task-related parameter 332. This involves identifying the existing workflow using a mapping between the task-related parameter 332 (which encapsulates the nature or scope of the desired modification) and a particular sequence of operations or set of functions that are part of the application's existing workflows.

At block 914, a determination is made to check whether an existing workflow has been identified. For example, if the analysis engine 312 determines that the existing workflow has been identified within the first application 208-1, the method 900 proceeds to block 916 (‘Yes’ path from block 914). On the other hand, if the analysis engine 312 fails to identify the existing workflow within the first application 208-1 that corresponds to the determined task-related parameter 332, the method proceeds to block 918 (‘No’ path from block 914).

At block 916, a control instruction is generated for a workflow and task management engine to modify the existing workflow. For example, the analysis engine 312 is to generate one or more control instructions to be transmitted to the management engine 314 (or management engine 220) to modify the identified workflow. This control instruction encapsulates the specific changes to be made to the existing workflow of the first application 208-1, as informed by the user response(s) 322 and the determined task-related parameter 332. In an example, the control instruction serves as a command that triggers the management engine 314 to initiate the process of updating the existing workflow. While identifying the presence of existing workflows within the first application 208-1, it is important to ensure that the identified workflow is the correct target for the modifications suggested by the user feedback. This precision in identification is paramount to effectively addressing the user's concerns and enhancing the application in a way that is meaningful and impactful.

At block 918, a control instruction is generated for the workflow and task management engine to create a new task catering to the requirements of the user. For example, the analysis engine 312 is to communicate with the management engine 314 to facilitate creation of a new task. In an example, the new task is not arbitrary, rather it is specifically formulated based on the requirements of the user 204-1 which has been determined by analyzing their response indicating patterns, trends, and sentiments of the user.

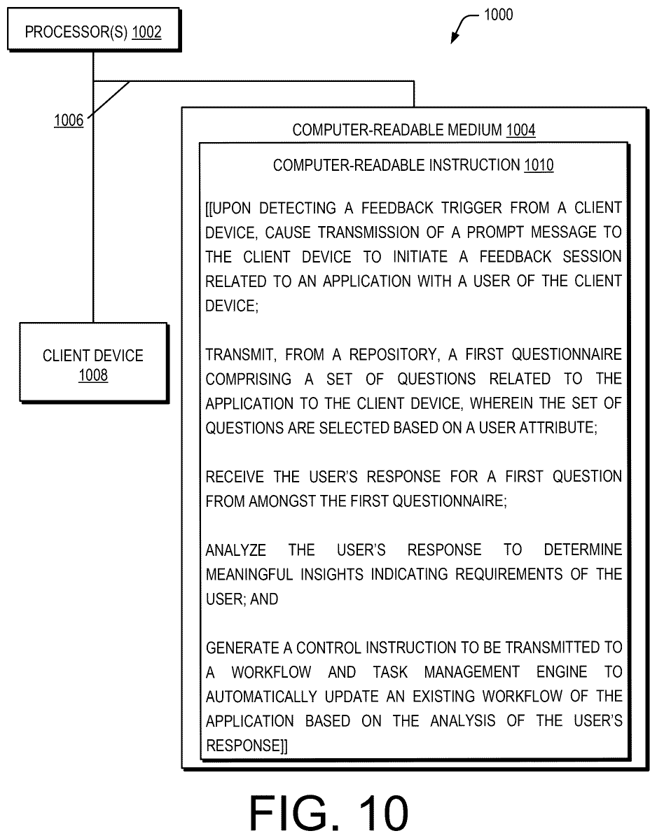

FIG. 10 illustrates a computing environment 1000 implementing a non-transitory computer readable medium for modifying workflow of an application based on received user's response. In an example, the computing environment 1000 includes processor(s) 1002 communicatively coupled to a non-transitory computer readable medium 1004 through a communication link 1006. In an example implementation, the computing environment 1000 may be for example, the environment 200. In an example, the processor(s) 1002 may have one or more processing resources for fetching and executing computer-readable instructions from the non-transitory computer readable medium 1004. The processor(s) 1002 and the non-transitory computer readable medium 1004 may be implemented, for example, in feedback management system 216 (as has been described in conjunction with the preceding figures).

The non-transitory computer readable medium 1004 may be, for example, an internal memory device or an external memory device. In an example implementation, the communication link 1006 may be a network communication link. The processor(s) 1002 and the non-transitory computer readable medium 1004 may also be communicatively coupled to a computing device 1008 over the network.

In an example implementation, the non-transitory computer readable medium 1004 includes a set of computer readable instructions 1010 (referred to as instructions 1010) which may be accessed by the processor(s) 1002 through the communication link 1006. Referring to FIG. 10, in an example, the non-transitory computer readable medium 1004 includes instructions 1010 that cause the processor(s) 1002 to continuously monitor and detect a feedback trigger happened on a client device, such as client device 202-1, and in response to that, transmits a prompt message to the client device 202-1 to initiate a feedback session related to an application. As described previously, the feedback trigger is an event or condition detected by the processor(s) 1002 that indicates that the user 204-1 on its client device 202-1 has performed an action that warrants the initiation of the feedback session. In an example, the transmitted prompt message is the starting point of the feedback session and is designed to engage the user 204-1 in providing feedback about their experience with the application, e.g., first application 208-1.

Thereafter, the instructions 1010 cause the processor(s) 1002 to transmit the first questionnaire 320, including questions related to the first application 208-1 from the repository 218, to the client device 202-1. In an example, the first questionnaire 320 is composed of set of questions that are relevant to the first application 208-1. It may be noted that, the selection of these set of questions is based on specific user attribute(s) 318. The user attribute(s) 318 may include the details related to the user's role within the first application 208-1, user's usage pattern, preferences, or any other relevant user data that may customize the first questionnaire 320. Further, the first questionnaire 320 is transmitted to the client device 202-1 through a network connection using a secured communication protocol. Such transmission ensures that the first questionnaire 320 is presented to the user 204-1 on its client device 202-1, enabling feedback.

On receiving the first questionnaire 320, the client device 202-1 presents the first questionnaire 320 onto a display to be viewed and responded to by the user 204-1. Once user 204-1 responded by providing feedback or answers, instructions 1010 causes the processor(s) 1002 to receive the user response(s) 322 for a first question from among the first questionnaire 320. Although, the present example has been described in context of first question being answered by the user 204-1, however, any of the question regardless of their position in the first questionnaire 320 may be answered without deviating from the scope of the present subject matter.

After receiving the user response(s) 322 for the answered first question, the instructions 1010 causes the processor(s) 1002 to analyze the user response(s) 322 provided by the user 204-1 for the first question to obtain meaningful insights representing requirement of the user 204-1. In an example, the meaning insights indicates patterns, trends, and sentiments of the user 204-1 in the user response(s) 322 or with respect to historical user responses received during earlier feedback sessions. In an example, the processor(s) 1002 is to perform in-depth analysis of the user response(s) 322, by utilizing techniques such as NLP and machine learning to discern meaningful insights from the user response(s) 322. This analysis aims to extract actionable insights that reflect the user's experience and expectations regarding the application's functionality and performance.

Upon deriving meaningful insights from the user response(s) 322, the instructions 1010 causes the processor(s) 1002 to determine the task-related parameter 332. In an example, this task-related parameter 332 corresponds to a potential task for modifying an existing workflow of the first application 208-1. In an example, the task-related parameter 332 is indicative of the nature or scope of the proposed modification, providing a clear and actionable directive for modifying the first application 208-1 in alignment with user feedback. For example, if the analysis reveals that users find a particular feature cumbersome, the task-related parameter may define a task aimed at simplifying the user interface for that feature. Alternatively, if users suggest the addition of a new capability, the task-related parameter 332 may outline the development of this new function within the application's workflow.

To this end, once the task-related parameter is determined, the instructions 1010 causes the processor(s) 1002 to identify an existing workflow within the first application 208-1 that corresponds to the determined task-related parameter 332. This involves identifying the existing workflow using a mapping between the task-related parameter 332 (which encapsulates the nature or scope of the desired modification) and a particular sequence of operations or set of functions that are part of the application's existing workflows.

Once the relevant workflow is identified, the instructions 1010 causes the processor(s) 1002 to generate one or more control instructions to be transmitted to the management engine 314 (or to management engine 220) to modify the identified workflow. This control instruction encapsulates the specific changes to be made to the existing workflow of the application, as informed by the user response(s) 322 and the determined task-related parameter 332. In an example, the control instruction serves as a command that triggers the management engine 314 to initiate the process of updating the existing workflow. While identifying the presence of existing workflows within the first application 208-1, it is important to ensure that the identified workflow is the correct target for the modifications suggested by the user feedback. This precision in identification is paramount to effectively addressing the user's concerns and enhancing the application in a way that is meaningful and impactful.

In another example, in the event that the analysis engine 312 fails to identify the workflow within the first application 208-1 that corresponds to the determined task-related parameter 332, an alternative course of action is initiated, i.e., instead of modifying the workflow, the instructions 1010 causes the processor(s) 1002 to communicate with the management engine 314 to facilitate creation of a new task. In an example, the new task is not arbitrary, rather it is specifically formulated based on the requirements of the user 204-1 which has been determined by analyzing their response indicating patterns, trends, and sentiments of the user.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
a machine-readable storage medium comprising instructions executable by the processor to:
upon detecting a feedback trigger from a client device, cause transmission of a prompt message to the client device to initiate a feedback session related to an application, with a user of the client device;
transmit, from a repository, a first questionnaire comprising a set of questions related to the application to the client device, wherein the set of questions are selected based on a user attribute;
receive the user's response for a first question from amongst the first questionnaire;
assign a first metric score to the user on receiving the user's response for the first question; and
cause to transition a current state of the user having access to a first set of functions to an augmented state having access to a second set of functions within the application based on the first metric score.

2. The system of claim 1, wherein the user attribute is determined based on one of a profile of the user comprising a user's designated role in the application, data corresponding to a user's historical interaction with the application, and frequency of interaction with the application.

3. The system of claim 1, wherein on receiving the user's response, the instructions are executable to:
parse the user's response to identify and remove non-relevant components from the user's response to obtain a parsed user's response, wherein the user's response is obtained in one of a free-text format and as a selection from multiple-choice options;
analyze the parsed user's response to determine a set of response attributes indicating patterns and trends in the user's response;
execute a search query generated based on the set of response attributes on the repository to extract a set of relevant questions for the user; and
modify an order and a content of the questions of the first questionnaire based on the set of relevant questions to transmit an updated questionnaire to the client device.

4. The system of claim 3, wherein the instructions are executable to:
determine a task-related parameter that corresponds to a potential task having a workflow which is to be modified based on the analysis of the user's response, wherein the task-related parameter is indicative of one of a nature and a scope of the modification;
identify an existing workflow within the application that corresponds to the task-related parameter, wherein the existing workflow is a target workflow which is to be modified; and
generate a control instruction to be transmitted to a workflow and task management engine to automatically update the existing workflow of the application based on the determined task-related parameter.

5. The system of claim 1, wherein the metric score is assigned to the user based on a weight associated with the first question of the first questionnaire, wherein the weight is associated with the first question based on a relevance of the first question, category of the first question, role of the user, and pattern in user's response.

6. The system of claim 1, wherein to transition from a current state to an augmented state, the instructions are executable to:
compare the first metric score assigned to the user with one of a threshold milestone of a plurality of threshold milestones; and
on determining the first metric score to exceed one of the threshold milestones, cause to transition the user from the current state having access to the first set of functions to the augmented state having access to the second set of functions.

7. The system of claim 6, wherein the instructions are executable to:
on determining the first metric score to be less than each of the threshold milestones of the plurality of threshold milestones, continue to receive user's response for a subsequent question present within the questionnaire;
assign a second metric score to the user on receiving user's response for the subsequent question;
accumulate the second metric score with the first metric score to obtain an accumulated metric score;
compare the accumulated metric scores assigned to the user with the plurality of threshold milestones; and
on determining the accumulated metric scores to exceed one of the threshold milestones of the plurality of threshold milestones, cause to transition the current state of the user having access to the first set of functions to the augmented state having access to the second set of functions.

8. The system of claim 1, wherein the second set of functions are different from the first set of functions reflecting an increase in features, functions, and services offered by the application as the user state transitions from the current state to the augmented state.

9. A method comprising:
upon detecting a feedback trigger from a client device, causing transmission of a prompt message to the client device to initiate a feedback session related to an application with a user of the client device;
transmitting, from a repository, a first questionnaire comprising a set of questions related to the application to the client device, wherein the set of questions are selected based on a user attribute;
receiving the user's response for a first question from amongst the first questionnaire;
analyzing the user's response provided by a user to detect patterns and trends within the user's response; and
modifying the questions of the first questionnaire based on the analysis of the user's response to transmit an updated questionnaire to the client device.

10. The method of claim 9, wherein the user attribute is determined based on one of a specific profile of the user comprising a user's designated role in the application, data corresponding to a user's historical interaction with the application, and frequency of interaction with the application.

11. The method of claim 9, on receiving the user's response, the method comprises:
parsing the user's response to identify and remove non-relevant components from the user's response to obtain a parsed user response, wherein the user's response is obtained in one of a free-text format and as a selection from multiple-choice options;
analyzing the parsed user response to determine a set of response attributes indicating patterns and trends within the user's response;
executing a search query generated based on the set of response attributes on the repository to extract a set of relevant questions for the user; and
modifying an order and a content of the questions of the first questionnaire based on the set of relevant questions to transmit the updated questionnaire to the client device.

12. The method of claim 9, wherein the method comprises:
assigning a first metric score to the user on receiving user's response for the first question, wherein the first metric score is assigned based on a weight associated with the first question of the first questionnaire;
compare the first metric score with one of a threshold milestone of a plurality of threshold milestones;
on determining the first metric score to exceed one of the threshold milestones of the plurality of threshold milestones, causing transitioning of a current state of the user having access to a first set of functions to an augmented state having access to a second set of functions within the application.

13. The method of claim 12, wherein the method comprises:
on determining the first metric score to be less than each of the threshold milestone of the plurality of threshold milestones, continuing receiving user's response for a subsequent question present within the questionnaire;
assigning a second metric score to the user on receiving user's response for the subsequent question;
accumulating the second metric score with the first metric score to obtain an accumulated metric score;
comparing the accumulated metric score assigned to the user with the plurality of threshold milestones; and
on determining the accumulated metric score to exceed one of the threshold milestones of the plurality of threshold milestones, causing transitioning of the current state of the user having access to the first set of functions to the augmented state having access to the second set of functions.

14. The method of claim 12, wherein the weight is associated with each question present in the repository based on the relevance and impact of the question, category of the question, role of the user, and pattern in user's response.

15. The method of claims 13, wherein the second set of functions are different from the first set of functions reflecting an increase in features, functions, and services offered by the application as the user state transitions from the current state to the augmented state.

16. The method of claim 9, wherein the method comprises:
determining a task-related parameter that corresponds to a potential task for modifying an existing workflow of the application based on the analysis of the user's response, wherein the task-related parameter is indicative of one of a nature and a scope of the modification;
identify the existing workflow within the application that corresponds to the task-related parameter, wherein the existing workflow is a target workflow which is to be modified; and
generate a control instruction to be transmitted to a workflow and task management engine to automatically update the existing workflow of the application.

17. A non-transitory computer-readable medium comprising instructions, the instructions being executable by a processing resource of a system, to:
upon detecting a feedback trigger from a client device, cause transmission of a prompt message to the client device to initiate a feedback session related to an application with a user of the client device;
transmit, from a repository, a first questionnaire comprising a set of questions related to the application to the client device, wherein the set of questions are selected based on a user attribute;
receive the user's response for a first question from amongst the first questionnaire;
analyze the user's response to determine meaningful insights indicating requirement of the user; and
generate a control instruction to be transmitted to a workflow and task management engine to automatically update an existing workflow of the application based on the analysis of the user's response.

18. The non-transitory computer-readable medium of claim 17, wherein the instructions being executable are to:
determine a task-related parameter that corresponds to a potential task having a workflow which is to be modified based on the analysis of the user's response, wherein the task-related parameter is indicative of one of a nature and a scope of the modification;
identify an existing workflow within the application that corresponds to the task-related parameter, wherein the existing workflow is the target workflow which is to be modified; and
on identifying the target workflow, generate a control instruction based on the task-related parameter, wherein the control instruction is to be transmitted to a workflow and task management engine to automatically modify the target workflow of the application; or
when target workflow not identified, generate control instructions to be transmitted to the workflow and task management engine to automatically create a new task catering to the requirements of the user, wherein the new task enable actionable follow-up by development team based on meaningful insights gained from the user's response.

19. The non-transitory computer-readable medium of claim 17, wherein the instructions being executable are to:
assign a first metric score to the user on receiving the user's response for the first question, wherein the first metric score is assigned to the user based on a weight associated with the first question;
compare the first metric score assigned to the user with one of a threshold milestone of a plurality of threshold milestones; and
on determining the first metric score to exceed one of the threshold milestones of the plurality of threshold milestones, cause to transition a current state of the user having access to a first set of functions to an augmented state having access to a second set of functions within the application.

20. The non-transitory computer-readable medium of claim 17, wherein the instructions being executable are to:
analyze the user's response for the first question from amongst the first questionnaire to detect patterns and trends within the user's response; and
modify the questions of the first questionnaire based on the analysis of the user's response to transmit an updated questionnaire to the client device of the user.
